(19) United States
(12) Patent Application Publication
(10) Pub. No.: US 2026/0226669 A1
(43) Pub. Date: Aug. 6, 2026

(54) CLOTHES TREATING APPARATUS

(71) Applicant: SAMSUNG ELECTRONICS CO., LTD., Suwon-si (KR)

(72) Inventors: Jinyounggeul OH, Suwon-si (KR); Hyeongyu IM, Suwon-si (KR); Hakjae LEE, Suwon-si (KR)

(21) Appl. No.: 19/456,538

(22) Filed: Jan. 22, 2026

Related U.S. Application Data
(63) Continuation of application No. PCT/KR2026/000488, filed on Jan. 9, 2026.

(30) Foreign Application Priority Data
Feb. 5, 2025 (KR) 10-2025-0014780

(51) Int. Cl. D06F 58/20; B08B 3/02

(52) U.S. Cl. CPC D06F 58/20; B08B 3/02

(57) ABSTRACT

A clothes treating apparatus includes a tub, a heat exchanger disposed above the tub, a drying cover covering an upper portion of the heat exchanger, and a nozzle device fastened to the drying cover in a vertical direction and configured to spray washing water onto the heat exchanger. The nozzle device includes a nozzle comprising a plurality of nozzle holes configured to spray the washing water onto the heat exchanger, a sealing member comprising a seal surrounding an edge of the nozzle, an upper nozzle case fastened to the drying cover, a lower nozzle case assembled to a lower portion of the upper nozzle case and configured to seat the nozzle therein, and a leakage-proof rib extending downwardly from an upper wall of the upper nozzle case and configured to receive the lower nozzle case.

### CROSS-REFERENCE TO RELATED APPLICATIONS

This application is a continuation of International Application No. PCT/KR2026/000488 designating the United States, filed on January 9, 2026, in the Korean Intellectual Property Receiving Office and claiming priority to Korean Patent Application No.10-2025-0014780, filed on February 5, 2025, in the Korean Intellectual Property Office, the disclosures of each of which are incorporated by reference herein in their entireties.

### BACKGROUND

### Field

The disclosure relates to a clothes treating apparatus with improved assemblability of a nozzle device for washing a heat exchanger.

### Description of Related Art

A clothes treating apparatus is an appliance for treating and/or managing clothes. The clothes treating apparatus may include a washing machine and a dryer. The washing machine may include a washing machine with a drying function such as a washer dryer combo.

The washing machine with a drying function performs washing through mutual friction by stirring together laundry, water, and detergent inside a tub by means of the driving force of a drive motor.

Cycles performed by the washing machine with a drying function may include a washing cycle of supplying water and detergent to a tub in which laundry is received and washing the laundry by rotating a drum, a rinsing cycle of supplying water to the tub and rinsing the laundry by rotating the drum, and a dewatering cycle of discharging water from the tub and removing moisture from the laundry by rotating the drum.

Cycles performed by the washing machine with a drying function may include a drying cycle of drying the laundry by blowing heat generated from a drying device into a receiving space in which the laundry is received. The washing machine with a drying function may include a drying device to perform the drying cycle.

The drying device may include a heat exchanger for generating heat, and the heat exchanger may be cleaned by washing water sprayed from a nozzle device located above the heat exchanger.

### SUMMARY

Embodiments of the disclosure provide a clothes treating apparatus with improved assemblability of a nozzle device for washing a heat exchanger.

Embodiments of the disclosure provide a clothes treating apparatus in which a sealing member that seals a nozzle to prevent/reduce leakage of washing water supplied to a nozzle device is formed to surround an edge of the nozzle, thereby simplifying the shape of the sealing member.

Embodiments of the disclosure provide a clothes treating apparatus that allows a nozzle assembled with a sealing member to be easily seated in a lower nozzle case by simplifying the shape of the sealing member.

Embodiments of the disclosure provide a clothes treating apparatus that allows a nozzle device to be easily fastened to a drying cover by fastening the nozzle device to the drying cover in a vertical direction.

Embodiments of the disclosure provide a clothes treating apparatus capable of minimizing/reducing a gap between a nozzle device and a heat exchanger by fastening the nozzle device to a drying cover in a vertical direction.

Embodiments of the disclosure provide a clothes treating apparatus in which an anti-leakage rib for preventing/reducing leakage of washing water supplied to a nozzle device is formed on an upper nozzle case, thereby dually preventing/reducing leakage of the washing water.

A clothes treating apparatus according an example embodiment of the present disclosure includes: a tub, a heat exchanger disposed above the tub, a drying cover covering an upper portion of the heat exchanger, and a nozzle device fastened to the drying cover in a vertical direction and configured to spray washing water onto the heat exchanger, wherein the nozzle device includes: a nozzle comprising a plurality of nozzle holes configured to spray the washing water onto the heat exchanger, a sealing member comprising a seal configured to surround an edge of the nozzle, an upper nozzle case fastened to the drying cover, a lower nozzle case assembled to a lower portion of the upper nozzle case and configured to seat the nozzle therein, and a leakage-proof rib extending downwardly from an upper wall of the upper nozzle case and configured to receive the lower nozzle case.

A clothes treating apparatus according to an example embodiment of the present disclosure includes: a tub, a heat exchanger disposed above the tub, a drying cover covering an upper portion of the heat exchanger and including a receiving hole, and a nozzle device fastened to the drying cover in a vertical direction such that a portion thereof is received in the receiving hole, and configured to spray washing water onto the heat exchanger, wherein the nozzle device includes: a nozzle including a plurality of nozzle holes configured to spray the washing water onto the heat exchanger, a sealing member comprising a seal assembled to the nozzle to surround an edge of the nozzle, an upper nozzle case fastened to the drying cover, a lower nozzle case assembled to a lower portion of the upper nozzle case to be received in the receiving hole and configured to seat the nozzle therein, and a leakage-proof rib extending downwardly from an upper wall of the upper nozzle case and positioned between the receiving hole and the lower nozzle case.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a perspective view of a clothes treating apparatus according to various embodiments.

FIG. 2 is a cross-sectional view of the clothes treating apparatus according to various embodiments.

FIG. 3 is an exploded perspective view of an interior of the clothes treating apparatus according to various embodiments.

FIG. 4 is an exploded perspective view of a portion of a configuration arranged within the clothes treating apparatus from a direction different from that shown in FIG. 3 according to various embodiments.

FIG. 5 is an exploded perspective view of a nozzle device fastened to a drying cover according to various embodiments.

FIG. 6 is a perspective view of the nozzle device fastened to the drying cover according to various embodiments.

FIG. 7 is an exploded perspective view of the nozzle device according to various embodiments.

FIG. 8 is a perspective cross-sectional view of the nozzle device according to various embodiments.

FIG. 9 is a cross-sectional view of the nozzle device being fastened to the drying cover according to various embodiments.

FIG. 10 is a cross-sectional view of the nozzle device fastened to the drying cover, according to various embodiments.

FIG. 11 is an exploded perspective view of a state in which a nozzle and a sealing member are integrally provided in FIG. 5 according to various embodiments.

FIG. 12 is a cross-sectional view of a state in which washing water is supplied to the nozzle device through a water supply pipe and the washing water supplied to the nozzle device is sprayed onto a heat exchanger through a plurality of nozzle holes, according to various embodiments.

FIG. 13 is a cross-sectional view of a state in which the washing water supplied to the nozzle device to be sprayed through a plurality of nozzle holes is prevented/blocked from leaking out of an upper nozzle case by a leakage-proof rib, according to various embodiments.

FIG. 14 is a cross-sectional view of a gap between a leakage-proof rib and a receiving hole formed wider than a gap between the leakage-proof rib and a lower nozzle case in FIG. 13 according to various embodiments.

FIG. 15 is a cross-sectional view of a leakage-proof rib provided to extend further downward than a lower end of a lower nozzle case in FIG. 13 according to various embodiments.

FIG. 16 is an exploded perspective view of an anti-leakage sealing member provided between a drying cover and a nozzle device fastened to the drying cover, according to various embodiments.

FIG. 17 is a cross-sectional view of the anti-leakage sealing member provided between the drying cover and the nozzle device fastened to the drying cover, according to various embodiments.

### DETAILED DESCRIPTION

Various example embodiments of the disclosure and terms used herein are not intended to limit the technical features described herein, and should be understood to include various modifications, equivalents, or substitutions of the corresponding embodiments.

In describing of the drawings, similar reference numerals may be used for similar or related elements.

The singular form of a noun corresponding to an item may include one or more of the items unless clearly indicated otherwise in a related context.

In the disclosure, phrases, such as “A or B”, “at least one of A and B”, “at least one of A or B”, “A, B or C”, “at least one of A, B and C”, and “at least one of A, B, or C” may include any one or all possible combinations of the items listed together in the corresponding phrase among the phrases.

As used herein, the term “and/or” includes any and all combinations of one or more of the associated listed items.

Terms such as “1st”, “2nd”, “primary”, or “secondary” may be used simply to distinguish an element from other elements, without limiting the element in other aspects (e.g., importance or order).

When an element (e.g., a first element) is referred to as being “(functionally or communicatively) coupled” or “connected” to another element (e.g., a second element), the first element may be connected to the second element, directly (e.g., wired), wirelessly, or through a third element.

It will be understood that when the terms “includes”, “comprises”, “including”, and/or “comprising” are used in the disclosure, they specify the presence of the specified features, figures, steps, operations, components, members, or combinations thereof, but do not preclude the presence or addition of one or more other features, figures, steps, operations, components, members, or combinations thereof.

When a given element is referred to as being “connected to”, “coupled to”, “supported by” or “in contact with” another element, it is to be understood that it may be directly or indirectly connected to, coupled to, supported by, or in contact with the other element. When a given element is indirectly connected to, coupled to, supported by, or in contact with another element, it is to be understood that it may be connected to, coupled to, supported by, or in contact with the other element through a third element.

It will also be understood that when an element is referred to as being “on” another element, it may be directly on the other element or intervening elements may also be present.

A washing machine according to various embodiments may perform washing, rinsing, spin-drying, and drying processes. The washing machine is an example of a clothes treating apparatus, and the clothes treating apparatus is a concept including a device capable of washing clothes (objects to be washed, and objects to be dried), a device capable of drying clothes, and a device capable of washing and drying clothes.

The washing machine according to various embodiments may include a top-loading washing machine in which a laundry inlet for inserting or removing laundry is provided to face upward, or a front-loading washing machine in which a laundry inlet is provided to face forward. The washing machine according to various embodiments may include a washing machine of a loading type other than the top-loading washing machine and the front-loading washing machine.

For the top-loading washing machine, laundry may be washed using water current generated by a rotating body such as a pulsator. For the front-loading washing machine, laundry may be washed by repeatedly lifting and lowering laundry by rotating a drum. The front-loading washing machine may include a dryer combined washing machine capable of drying laundry stored in a drum. The dryer combined washing machine may include a hot air supply device for supplying high-temperature air into the drum. For example, the dryer combined washing machine may include a heater. The washing machine according to various embodiments may include a washing machine using a washing method other than the above-described washing method.

The washing machine according to various embodiments may include a housing accommodating various components therein. The housing may be provided in the form of a box including a laundry inlet on one side thereof.

The washing machine may include a door for opening and closing the laundry inlet. The door may be rotatably mounted to the housing by a hinge. At least a portion of the door may be transparent or translucent to allow the inside of the housing to be visible.

The washing machine may include a tub disposed within the housing to store water. The tub may be formed in a substantially cylindrical shape with a tub opening formed on one side thereof. The tub may be disposed inside the housing in such a way that the tub opening corresponds to the laundry inlet.

The tub may be connected to the housing by a damper. The damper may absorb vibration generated when the drum rotates, and the damper may reduce vibration transmitted to the housing.

The washing machine may include a drum provided to accommodate laundry.

The drum may be disposed inside the tub such that a drum opening provided on one side of the drum corresponds to the laundry inlet and the tub opening. Laundry may pass sequentially through the laundry inlet, the tub opening, and the drum opening and then be received in the drum or removed from the drum.

The drum may perform each operation according to washing, rinsing, and/or spin-drying while rotating in the tub. A plurality of through holes may be formed in a cylindrical wall of the drum to allow water stored in the tub to be introduced into or to be discharged from the drum.

The washing machine may include a driving device configured to rotate the drum. The driving device may include a drive motor and a rotating shaft for transmitting a driving force generated by the drive motor to the drum. The rotating shaft may penetrate the tub to be connected to the drum.

The driving device may perform respective operations according to washing, rinsing, and/or spin-drying, or drying processes by rotating the drum in a forward or reverse direction.

The washing machine may include a water supply device configured to supply water to the tub. The water supply device may include a water supply pipe and a water supply valve disposed in the water supply pipe. The water supply pipe may be connected to an external water supply source. The water supply pipe may extend from an external water supply source to a detergent supply device and/or the tub. Water may be supplied to the tub through the detergent supply device. Alternatively, water may be supplied to the tub without passing through the detergent supply device.

The water supply valve may open or close the water supply pipe in response to an electrical signal from a controller. The water supply valve may allow or block the supply of water to the tub from an external water supply source. The water supply valve may include a solenoid valve configured to open or close in response to an electrical signal.

The washing machine may include a detergent supply device configured to supply detergent to the tub. The detergent supply device may include a manual detergent supply device that requires a user to enter detergent to be used for each washing, and an automatic detergent supply device that stores a large amount of detergent and automatically adds a predetermined amount of detergent during washing. The detergent supply device may include a detergent container for storing detergent. The detergent supply device may be configured to supply detergent into the tub during a water supply process. Water supplied through the water supply pipe may be mixed with detergent via the detergent supply device. Water mixed with detergent may be supplied into the tub. Detergent is used as a term including detergent for pre-washing, detergent for main washing, fabric softener, bleach, etc., and the detergent container may be partitioned into a storage region for the pre-washing detergent, a storage region for the main washing detergent, a storage region for the fabric softener, and a storage region for the bleach.

The washing machine may include a drainage device configured to discharge water contained in the tub to the outside. The drainage device may include a drain pipe extending from a bottom of the tub to the outside of the housing, a drain valve disposed on the drain pipe to open or close the drain pipe, and a pump disposed on the drain pipe. The pump may pump water from the drain pipe to the outside of the housing.

The washing machine may include a control panel disposed on one side of the housing. The control panel may provide a user interface for interaction between a user and the washing machine. The user interface may include at least one input interface and at least one output interface each comprising various circuitry.

The at least one input interface may convert sensory information received from a user into an electrical signal.

The at least one input interface may include a power button, an operation button, a course selection dial (or a course selection button), and a washing/rinsing/spin-drying setting button. The at least one input interface may include a tact switch, a push switch, a slide switch, a toggle switch, a micro switch, a touch switch, a touch pad, a touch screen, a jog dial, and/or a microphone.

The at least one output interface may visually or audibly transmit information related to the operation of the washing machine to a user.

For example, the at least one output interface may transmit information related to a washing course, operation time of the washing machine, and washing/rinsing/spin-drying settings to the user. Information about the operation of the washing machine may be output via a screen, an indicator, or a voice. The at least one output interface may include a liquid crystal display (LCD) panel, a light emitting diode (LED) panel, or a speaker.

The washing machine may include a communication module including communication circuitry for wired and/or wireless communication with an external device.

The communication module may include at least one of a short-range wireless communication module and a long-range wireless communication module.

The communication module may transmit data to an external device (e.g., a server, a user device, and/or a home appliance) or receive data from the external device. For example, the communication module may establish communication with a server and/or a user device and/or a home appliance, and transmit and receive various types of data.

For the communication, the communication module may establish a direct (e.g., wired) communication channel or a wireless communication channel between the external devices, and support the performance of the communication through the established communication channel. According to an embodiment, the communication module may include a wireless communication module (e.g., a cellular communication module, a short-range wireless communication module, or a global navigation satellite system (GNSS) communication module) or a wired communication module (e.g., a local area network (LAN) communication module, or a power line communication module). Among these communication modules, the corresponding communication module may communicate with an external device through a first network (e.g., a short-range wireless communication network such as Bluetooth, wireless fidelity (Wi-Fi) direct, or infrared data association (IrDA)) or a second network (e.g., a long-range wireless communication network such as a legacy cellular network, a 5G network, a next-generation communication network, the Internet, or a computer network (e.g., LAN or wide area network WAN)). These various types of communication modules may be integrated as a single component (e.g., a single chip) or implemented as a plurality of separate components (e.g., multiple chips).

The short-range wireless communication module may include a Bluetooth communication module, a Bluetooth Low Energy (BLE) communication module, a near field communication module, a WLAN (Wi-Fi) communication module, and a Zigbee communication module, an IrDA communication module, a Wi-Fi Direct (WFD) communication module, an ultrawideband (UWB) communication module, an Ant+ communication module, a microwave (uWave) communication module, etc., but is not limited thereto.

The long-range wireless communication module may include a communication module that performs various types of long-range wireless communication, and may include a mobile communication circuitry. The mobile communication circuitry transmits and receives radio signals with at least one of a base station, an external terminal, and a server in a mobile communication network.

According to an embodiment, the communication module may communicate with an external device such as a server, a user device and other home appliances through an access point (AP). The AP may connect a LAN, to which a washing machine or a user device is connected, to a WAN to which a server is connected. The washing machine or the user device may be connected to the server via the WAN. The controller may control various components of the washing machine (e.g., the drive motor, and the water supply valve). The controller may control various components of the washing machine to perform at least one operation including water supply, washing, rinsing, and/or spin-drying according to a user input. For example, the controller may control the drive motor to adjust the rotational speed of the drum or control the water supply valve of the water supply device to supply water to the tub.

The controller may include various circuitry including hardware such as a CPU or memory, and software such as a control program. For example, the controller may include at least one memory for storing an algorithm and program-type data for controlling the operation of components in the washing machine, and at least one processor configured to perform the above-mentioned operation using the data stored in the at least one memory. The memory and the processor may each be implemented as separate chips. The processor may include one or more processor chips or may include one or more processing cores. The memory may include one or more memory chips or one or more memory blocks. Alternatively, the memory and the processor may be implemented as a single chip.

Hereinafter, a clothes treating apparatus according to various embodiments will be described in greater detail with reference to the accompanying drawings. Hereinafter, a washing machine with a drying function will be described as an example of the clothes treating apparatus. However, the disclosure is not limited to the washing machine with a drying function, and may be applied to various apparatuses for treating and/or caring for clothes.

In the following description, the terms “front”, rear”, “left”, and “right” are defined based on the drawings, and the shapes and positions of components are not limited by the terms.

For example, an X-axis direction may be defined as a front-to-back direction, a Y-axis direction may be defined as a left-to-right direction, and a Z-axis direction may be defined as an up-and-down direction.

Hereinafter, various example embodiments according to the present disclosure will be described in greater detail with reference to the accompanying drawings.

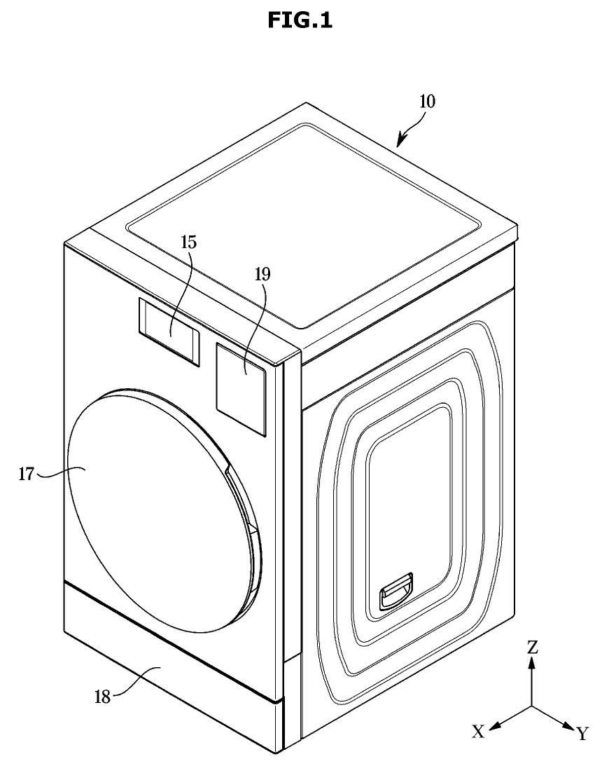

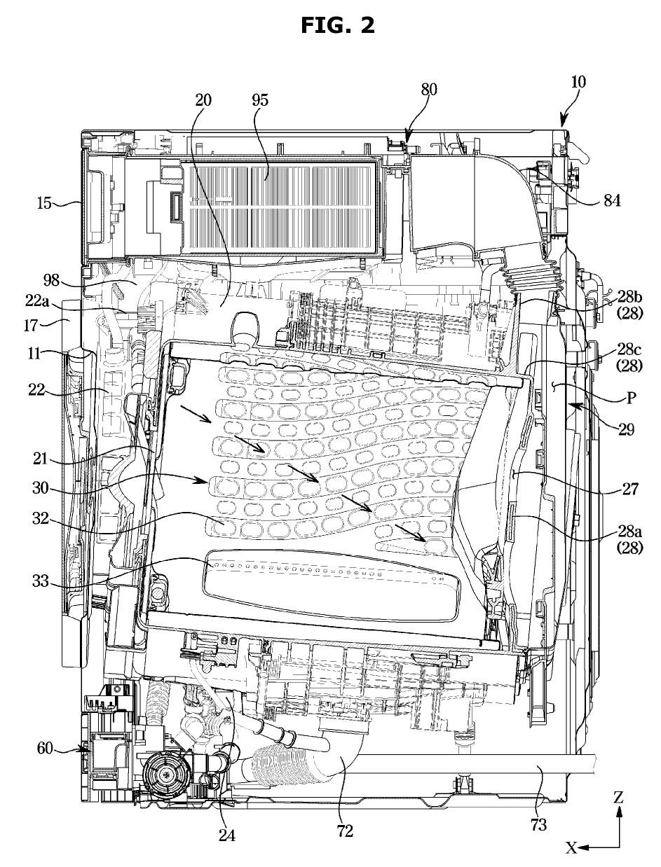

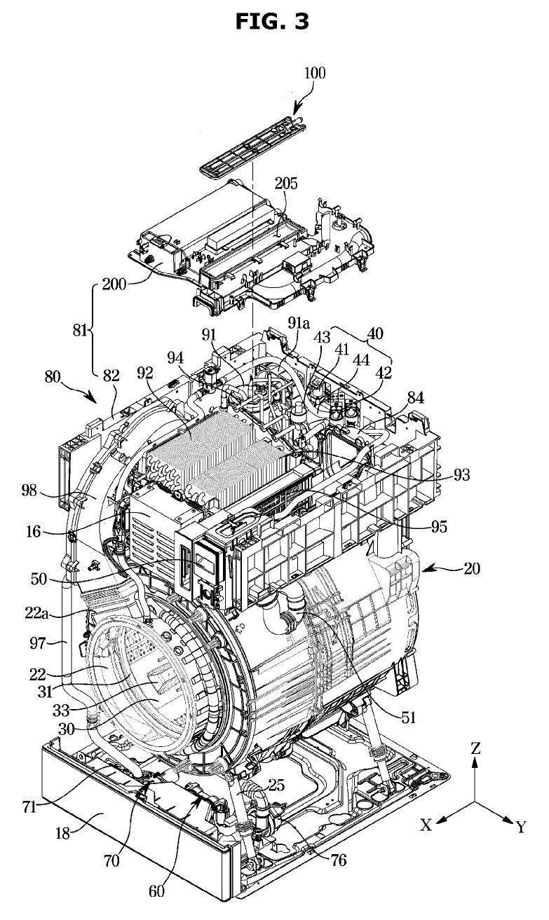

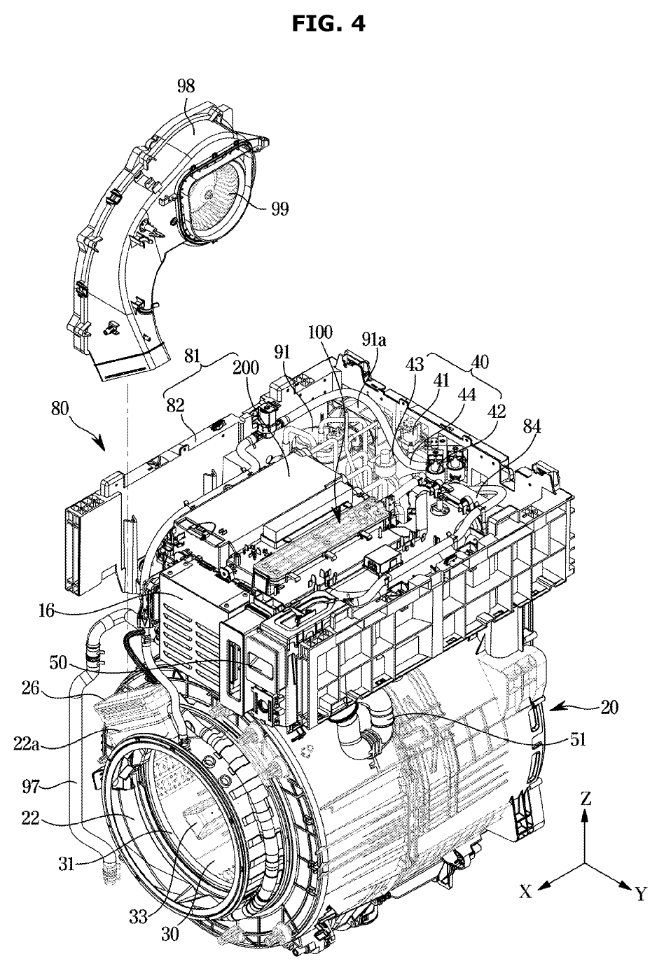

FIG. 1 is a perspective view of a clothes treating apparatus according to various embodiments. FIG. 2 is a cross-sectional view of the clothes treating apparatus according to various embodiments. FIG. 3 is an exploded perspective view of an interior of the clothes treating apparatus according to various embodiments. FIG. 4 is an exploded perspective view of a portion of a configuration arranged within the clothes treating apparatus from a direction different from that shown in FIG. 3 according to various embodiments.

As shown in FIGS. 1 to 4, a clothes treating apparatus according to various embodiments may include a housing 10 that accommodates various components therein. The housing 10 may be provided in the form of a box with a laundry inlet 11 formed on one side. The laundry inlet 11 may be provided to face substantially forward.

The clothes treating apparatus may include a laundry door 17 for opening or closing the laundry inlet 11. The laundry door 17 may be rotatably mounted to the housing 10 by a hinge. At least a portion of the laundry door 17 may be provided transparently or translucently to allow an interior of the housing 10 to be visible. In an example, the laundry door 17 may include tempered glass.

The clothes treating apparatus may include a lower door 18 configured to allow access to a lower detergent supply device 60. The clothes treating apparatus may include an upper door 19 configured to allow access to an upper detergent supply device 50 and a filter 95.

The clothes treating apparatus may include a control panel 15 disposed on one side of the housing 10. The control panel 15 may provide a user interface for interaction between a user and the clothes treating apparatus. The user interface may include at least one input interface 151 and at least one output interface 152.

The clothes treating apparatus may include a control box 16 for the control panel 15. The control box 16 may be electrically connected to the control panel 15. The control box 16 may supply power to the control panel 15. The control box 16 may process information input through the control panel 15. The control box 16 may control the control panel 15 to output information.

The clothes treating apparatus may include a tub 20 provided inside the housing 10 to store water. The tub 20 may be provided in a substantially cylindrical shape with a tub opening 21 formed on one side, and may be disposed inside the housing 10 such that the tub opening 21 is positioned to correspond to the laundry inlet 11. The tub opening 21 may be provided to face substantially forward.

The tub 20 may be connected to the housing 10 by a damper 25. The damper 25 may absorb vibrations generated during rotation of a drum 30 to attenuate vibrations transmitted to the housing 10.

The clothes treating apparatus may include a diaphragm 22 for connecting the tub 20 and the housing 10. In an example, the diaphragm 22 may extend between the laundry inlet 11 of the housing 10 and the tub opening 21 of the tub 20. The diaphragm 22 may be detachably mounted to the tub opening 21 of the tub 20. The diaphragm 22 may reduce the transmission of vibrations from the tub 20 to the housing 10. For example, the diaphragm 22 may include a more flexible material than the housing 10 and the tub 20.

The clothes treating apparatus may include the drum 30 configured receive laundry. At least one lifter 33 may be provided inside the drum 30 for performing washing by lifting and dropping the laundry.

The drum 30 may be disposed inside the tub 20 such that a drum opening 31 provided on one side corresponds to the laundry inlet 11 and the tub opening 21. Laundry may be put into or taken out of the drum 30 by passing sequentially through the laundry inlet 11, the tub opening 21, and the drum opening 31. The drum opening 31 may be provided to face substantially forward.

The drum 30 may perform respective operations according to washing, rinsing, and/or dewatering cycles while rotating inside the tub 20. A plurality of through-holes 32 may be formed in a cylindrical wall of the drum 30 to allow water stored in the tub 20 to flow into or out of the drum 30.

The clothes treating apparatus may include a drive device (not shown) configured to rotate the drum 30. The drive device may include a drive motor and a rotating shaft for transmitting a driving force generated from the drive motor to the drum 30. The rotating shaft may pass through the tub 20 to be connected to the drum 30.

The drive device may perform respective operations in accordance with washing, rinsing, and/or dewatering (e.g., spin-drying), or drying cycles by rotating the drum 30 in a forward or reverse direction.

The clothes treating apparatus may include a water supply device 40 configured to supply water to the tub 20. The water supply device 40 may include water supply valves 41 and 42 connectable to an external water source. For example, the water supply valves 41 and 42 may include a hot water valve 41 for supplying hot water and a cold water valve 42 for supplying cold water.

The water supply device 40 may include water supply pipes 43 and 44. The water supply pipes 43 and 44 may be provided as flexible hoses, plastic pipes, metal pipes, or the like. The water supply pipes 43 and 44 may be connected to the water supply valves 41 and 42, respectively. For example, the water supply pipes 43 and 44 may include a hot water pipe 43 connected to the hot water valve 41 and a cold water pipe 44 connected to the cold water valve 42.

At least one of the water supply pipes 43 and 44 may guide water from the water supply valves 41 and 42 to the tub 20. At least one of the water supply pipes 43 and 44 may extend from the water supply valves 41 and 42 to the tub 20. Water may be supplied to the lower detergent supply device 60 via the tub 20. Water may also be supplied to the lower detergent supply device 60 without passing through the tub 20.

The water supply valves 41 and 42 may open or close the water supply pipes 43 and 44 in response to an electrical signal from a controller (not shown). The water supply valves 41 and 42 may allow or block the supply of water from an external water source to the tub 20. For example, each of the water supply valves 41 and 42 may include a solenoid valve that opens or closes in response to an electrical signal.

The clothes treating apparatus may include detergent supply devices 50 and 60 configured to supply detergent to the tub 20. The detergent supply devices 50 and 60 may include the upper detergent supply device 50 and the lower detergent supply device 60. Detergent may be used as a term encompassing a pre-wash detergent, a main wash detergent, a fabric softener, a bleach, and the like.

The upper detergent supply device 50 may be positioned above the tub 20. The upper detergent supply device 50 may be positioned above the tub 20 in a vertical direction. The upper detergent supply device 50 may include a manual detergent supply device that requires a user to add detergent to be used for each washing, or an automatic detergent supply device that stores a large amount of detergent and automatically dispenses a given amount of detergent during washing. The upper detergent supply device 50 may be connected to the tub 20 through a detergent connection pipe 51. In an example, the upper detergent supply device 50 may be configured to supply solid laundry detergent and/or fabric softener to the tub 20. However, the type of detergent is not limited to the above example.

The lower detergent supply device 60 may be positioned below the tub 20. The lower detergent supply device 60 may be positioned below the tub 20 in the vertical direction. The lower detergent supply device 60 may include a manual detergent supply device that requires a user to add detergent to be used for each washing, or an automatic detergent supply device that stores a large amount of detergent and automatically dispenses a given amount of detergent during washing. In an example, the lower detergent supply device 60 may be configured to supply liquid laundry detergent and/or fabric softener to the tub 20. The type of detergent is not limited to the above example.

The clothes treating apparatus may include a drain device 70 configured to discharge water received in the tub 20 to an outside. The drain device 70 may include a drain pump 71 for discharging water from the tub 20 to the outside of the housing 10.

The clothes treating apparatus may include a circulation pump 76 for circulating water from the tub 20 back to the tub 20 via the lower detergent supply device 60.

The drain device 70 may be connected to the tub 20 through a tub connection pipe 72. The drain device 70 may discharge water in the tub 20 to the outside of the housing 10 through a first drain pipe 73.

The clothes treating apparatus may include a drying device 80 for drying laundry accommodated inside the drum 30. The drying device 80 may be configured to heat air and supply the heated air into the tub 20. The drying device 80 may be configured to dry and heat the air discharged from the tub 20, and to circulate the dried and heated air into the tub 20 to dry the clothes inside the drum 30. The drying device 80 according to various embodiments may be disposed above the tub 20.

The drying device 80 may include a drying case 81 in which a heat pump may be installed. The drying case 81 may include a drying base 82 and a drying cover 200 coupled to the drying base 82 to form a flow path through which air may move. The drying cover 200 may cover at least a portion of an open upper surface of the drying base 82. A drying flow path may be formed by the drying cover 200 and the drying base 82.

The drying device 80 according to various embodiments may be configured as a heat pump type. The drying device 80 may include a compressor 91, a condenser 92, an evaporator 93, an expansion valve, and a refrigerant pipe 94 through which refrigerant circulates. The compressor 91, the condenser 92, the evaporator 93, and the like, which comprise the heat pump, may be disposed in the drying case 81. The compressor 91, the condenser 92, the evaporator 93, and the like, which comprise the heat pump, may be disposed above the tub 20. For example, the drying device 80 may include a cooling fan 91a for cooling the compressor 91. In an example, the drying device 80 may be mounted as a single module.

The compressor 91 may compress the refrigerant, and the compressed high-temperature, high-pressure refrigerant may move to the condenser 92. The condenser 92 may cool the refrigerant to heat the surrounding air. The heated air may be introduced into the drum 30 to dry the clothes.

The refrigerant expanded through the expansion valve may absorb heat in the evaporator 93 and cool the surrounding air. In other words, the evaporator 93 may cool the high-temperature, high-humidity air that has passed through the interior of the drum 30 to remove moisture. The air from which moisture has been removed may pass through the condenser 92 and may be heated again while exchanging heat with the refrigerant passing through the condenser 92. In other words, the condenser 92 may heat the air that has passed through the evaporator 93. The condenser 92 and the evaporator 93 may correspond to heat exchangers. The condenser 92 may be referred to as a first heat exchanger. The evaporator 93 may be referred to as a second heat exchanger. In other words, the condenser 92 and the evaporator 93 may be referred to as heat exchangers 92 and 93.

The drying device 80 may include an inflow guide 84 connected to the tub 20. The inflow guide 84 may guide the air discharged from the tub 20 into an interior of the drying case 81. The inflow guide 84 may be in communication with an exhaust portion P formed in the tub 20. The air that has passed through the exhaust portion P may be introduced into the drying device 80 through the inflow guide 84.

A first end of the inflow guide 84 may be connected to the tub 20, and a second end opposite the first end of the inflow guide 84 may be connected to the drying case 81. For example, the inflow guide 84 may be configured to reduce the transmission of vibrations from the tub 20 to the drying device 80. The inflow guide 84 may include a more flexible material than the tub 20 and/or the drying case 81.

The drying device 80 may include the filter 95 for filtering out foreign substances such as lint included in the air introduced from the tub 20 through the exhaust portion P. The air introduced into the drying device 80 through the inflow guide 84 may pass through the filter 95 and then move to the evaporator 93 and the condenser 92. The filter 95 may be positioned on a flow path where the air introduced into the drying device 80 moves to the evaporator 93 and the condenser 92. The filter 95 may be detachably mounted to the drying case 81.

The condenser 92 and the evaporator 93 may be mounted on the drying case 81. The air introduced from the tub 20 to the drying device 80 may be humid air as it has dried the laundry while passing through the inside of the tub 20. The humid air may be cooled in the evaporator 93 of the drying device 80 to remove moisture. The air from which moisture has been removed in the evaporator 93 may be heated again while passing through the condenser 92.

The drying device 80 may include a nozzle device 100 for cleaning (e.g., washing) the condenser 92 and/or the evaporator 93. In an example, the nozzle device 100 may be fastened to the drying cover 200 of the drying case 81. The nozzle device 100 may be positioned above the condenser 92 and/or the evaporator 93. The nozzle device 100 may be supplied with water from the water supply device 40 and spray washing water toward the condenser 92 and/or the evaporator 93. The nozzle device 100 will be described in more detail later.

The clothes treating apparatus may include a second drain pipe 97 for guiding the water discharged from the drying device 80 to the tub 20. The second drain pipe 97 may be provided as a flexible hose, a plastic pipe, a metal pipe, or the like. The second drain pipe 97 may guide condensed water generated in the heat exchangers 92 and 93 of the drying device 80 to the outside of the drying device 80. The second drain pipe 97 may guide the water sprayed by the nozzle device 100 for washing the heat exchangers 92 and 93 to the outside of the drying device 80.

The second drain pipe 97 may be connected to the drain device 70. The second drain pipe 97 may be connected to the drain pump 71. The water discharged from the drying device 80 may flow to the drain device 70 along the second drain pipe 97. The water introduced into the drain device 70 through the second drain pipe 97 may be guided to the tub 20. The condensed water introduced into the tub 20 may be discharged to the outside of the clothes treating apparatus by operation of the drain pump 71.

The drying device 80 may include a fan 98 for supplying the air heated while passing through the condenser 92 back into the tub 20. The fan 98 may be disposed on one side of the condenser 92. For example, the fan 98 may be positioned on a second side of the condenser 92, which is opposite to a first side where the evaporator 93 is positioned. The fan 98 may extend downwardly to supply heated air into the drum 30. In the clothes treating apparatus according to an embodiment of the present disclosure, the fan 98 may be positioned on the second side of the condenser 92, which is opposite to the first side where the evaporator 93 is positioned, so that a space for arranging the control box 16 at a front end of the clothes treating apparatus may be ensured.

In an example, the fan 98 may be connected to the diaphragm 22. An end of the fan 98 from which air is discharged may be connected to the diaphragm 22. The diaphragm 22 may include a diaphragm connection portion 22a connected to the end of the fan 98. The diaphragm connection portion 22a may include an air inlet 26. The air discharged from the fan 98 may be fed into the drum 30 through the air inlet 26.

The fan 98 may include a supply fan 99 for blowing the heat-exchanged air into the tub 20. The supply fan 99 may be configured to supply air to the laundry within the drum 30. In an example, the supply fan 99 may be configured to draw in air in a direction of a rotation axis of the supply fan 99 and to discharge the air in an outward direction from a circumference of the supply fan 99. For example, the supply fan 99 may include a sirocco fan.

As the drying device 80 is connected to the tub 20, the air that dries the laundry inside the drum 30 may circulate to the drying device 80 and the tub 20. The clothes treating apparatus according to an embodiment of the present disclosure may be configured such that the air discharged from the tub 20 passes through the drying device 80 positioned above the tub 20 and is then fed into the tub 20.

The air heated in the drying device 80 may be supplied into the drum 30. To secure an area at which the heated air supplied into the drum 30 comes into contact with the laundry, a tub exhaust port 27 may be provided at a position opposite to the air inlet 26 through which the heated air from the drying device 80 is supplied to the tub 20. To increase a distance and/or time for the heated air to flow inside the drum 30 and thus have more contact the laundry, the tub exhaust port 27 may be provided at a position opposite to the air inlet 26 through which the heated air from the drying device 80 is supplied to the tub 20. The diaphragm 22, which is connected to the fan 98 to supply heated air to the drum 30, and the tub exhaust port 27 may be disposed spaced apart from each other. By increasing the area of contact between the heated air and the laundry, drying efficiency may be improved.

The air inlet 26 and the tub exhaust port 27 according to an embodiment of the present disclosure may be arranged to maximize/increase the use of the heated air provided from the drying device 80. In an example, the air inlet 26 may be positioned at a front end of the tub 20, and the tub exhaust port 27 may be positioned located at a rear end of the tub 20.

The clothes treating apparatus according to various embodiments may further include the exhaust portion P in which the air discharged from the inside of the tub 20 flows to the drying device 80. The exhaust portion P may be configured such that the air discharged from the tub exhaust port 27 flows to the inflow guide 84 of the drying device 80. The exhaust portion P may be configured to discharge the humid air that has passed through the tub 20. In an example, the exhaust portion P may be disposed on the rear side of the tub 20.

The air inside the tub 20 may be discharged to a tub duct 28 through the tub exhaust port 27 formed on a rear surface of the tub 20. The air discharged to the tub duct 28 may flow along the exhaust portion P and be supplied to the drying device 80.

The clothes treating apparatus according to various embodiments may include the tub duct 28 for forming at least a portion of the exhaust portion P. In an example, the tub duct 28 may be integrally formed with the tub 20. In an example, the tub 20 may include the tub duct 28. The tub duct 28 may be configured to surround the tub exhaust port 27.

The clothes treating apparatus may include a tub sealing member for sealing between the tub duct 28 and a duct cover 29. The tub sealing member may be provided along an edge of the tub duct 28 and/or the duct cover 29.

In the clothes treating apparatus according to various embodiments, the exhaust portion P may be formed by coupling the duct cover 29 to the tub duct 28.

The tub duct 28 according to an embodiment may include a recess portion 28a forming a portion of the exhaust portion P through which the air discharged from the inside of the tub 20 flows. Reinforcing ribs for enhancing the rigidity of the tub 20 may be provided on the rear surface of the tub 20, and the recess portion 28a may be provided as a portion recessed from an end of the reinforcing rib protruding from the rear surface of the tub 20. The recess portion 28a may be provided as a portion of the rear surface of the tub 20 where the reinforcing ribs are not formed. The tub exhaust port 27 for discharging air from the inside of the tub 20 may be formed in the recess portion 28a.

The tub duct 28 according to an embodiment may include a duct connection portion 28b forming another portion of the exhaust portion P through which the air that has passed through the recess portion 28a flows. The duct connection portion 28b may protrude outwardly from an outer circumferential surface of the tub 20. The duct connection portion 28b may protrude substantially upwardly from the outer circumferential surface of the tub 20.

The duct connection portion 28b may allow the recess portion 28a to communicate with the drying device 80. The duct connection portion 28b may be connected to the inflow guide 84 of the drying device 80. The duct connection portion 28b, together with the recess portion 28a and the duct cover 29, may form a single passage of the exhaust portion P.

The duct connection portion 28b may be covered by the duct cover 29. The duct connection portion 28b may be one on open side. The duct cover 29 may cover the open one side of the duct connection portion 28b.

The duct cover 29 may cover both the recess portion 28a and the duct connection portion 28b. For example, the duct cover 29 may cover both the open side of the recess portion 28a and the open side of the duct connection portion 28b. The exhaust portion P may be formed by the duct cover 29 covering the recess portion 28a and the duct connection portion 28b. In an example, the duct cover 29 may cover only the recess portion 28a.

The duct cover 29 may be configured to cover an open rear surface of the recess portion 28a and/or an open rear surface of the duct connection portion 28b. The exhaust portion P may be a single passage formed by the tub duct 28 and the duct cover 29 together.

The tub duct 28 may include a stepped portion 28c for expanding a cross-sectional area perpendicular to a direction of air flow in the exhaust portion P. The exhaust portion P may be configured such that a width of a portion formed by the duct connection portion 28b is greater than a width of a portion formed at the recess portion 28a by the stepped portion 28c. The stepped portion 28c may be formed such that the cross-sectional area perpendicular to the direction of air flow expands toward the direction of air flow from the exhaust portion P. The clothes treating apparatus may secure the size of the exhaust portion P by the stepped portion 28c and may efficiently utilize the internal space of the housing 10.

The water supply valves 41 and 42 of the clothes treating apparatus according to an embodiment of the present disclosure may be positioned by utilizing a remaining space due to such a mounting structure. In an embodiment of the present disclosure, the water supply valves 41 and 42 may be mounted between the inflow guide 84 and the cooling fan 91a. The water supply valves 41 and 42 may be positioned at a central portion of a rear surface of the drying device 80. The water supply valves 41 and 42 may be positioned at a rear of the condenser 92. The water supply valves 41 and 42 may be positioned in an area partitioned from the flow path through which drying air flows. The positions of the water supply valves 41 and 42 are not limited thereto. In an example, the water supply valves 41 and 42 may be mounted at a rear end of the drying case 81.

The clothes treating apparatus according to an embodiment of the present disclosure may include a washing water heater 24. The washing water heater 24 may be provided at a lower side of the tub 20 to heat washing water during washing. The water supply device 40 may supply a certain amount of water to the lower side of the tub 20 through the exhaust portion P during a drying cycle, and the washing water heater 24 may heat the water supplied into the tub 20 through the water supply device 40, the exhaust portion P, and the tub exhaust port 27 to generate steam. For example, the steam generated by the water supply device 40 and the washing water heater 24 may come into contact with clothes during the drying cycle, thereby maximally preventing/reducing wrinkles from forming on the clothes.

For example, the clothes treating apparatus according to an embodiment of the present disclosure, as a washing/drying combo machine, in contrast to a conventional dryer, may include the washing water heater 24 for heating washing water, and may generate steam by utilizing the washing water heater 24 and the water supply device 40 for washing the exhaust portion P to maximally prevent/reduce wrinkles from forming on the clothes during the drying cycle.

The drying device 80 may include the nozzle device 100 for washing the heat exchangers 92 and 93. The nozzle device 100 may be supplied with water from the water supply device 40 and spray water toward the heat exchangers 92 and 93. The water sprayed from the nozzle device 100 may wash one side of the heat exchangers 92 and 93.

The nozzle device 100 according to an embodiment may be configured to clean (e.g., wash) the heat exchangers 92 and 93. The nozzle device 100 may be configured to clean a portion of the heat exchangers 92 and 93 into which air is introduced. The nozzle device 100 may be configured to clean at least a portion of the evaporator 93. The nozzle device 100 may be configured to clean a portion of the evaporator 93 into which air that has passed through the filter 95 is introduced. The nozzle device 100 may be configured to clean a portion of the evaporator 93 that is contaminated by the air passing through the evaporator 93 and exchanging heat with the evaporator 93. The nozzle device 100 may be positioned adjacent to a portion of the evaporator 93 into which air is introduced.

The nozzle device 100 may be connected to the water supply device 40, and water may be supplied from the water supply device 40 to the nozzle device 100. The nozzle device 100 may be connected to the water supply pipes 43 and 44, and water may be supplied from the water supply valves 41 and 42 to the nozzle device 100. The water supply pipes 43 and 44 may form a water supply flow path for supplying water to the nozzle device 100. The water supply valves 41 and 42 may open or close the water supply flow path.

For example, the water supply device 40 may include the hot water valve 41, the cold water valve 42, the hot water pipe 43, and the cold water pipe 44. The hot water valve 41 may be referred to as a first water supply valve. The cold water valve 42 may be referred to as a second water supply valve. The hot water pipe 43 may be referred to as a first water supply flow path. The cold water pipe 44 may be referred to as a second water supply flow path.

The nozzle device 100 may be connected to the cold water pipe 44. When the cold water valve 42 is opened, cold water may be supplied from an external water source to the nozzle device 100 through the cold water pipe 44. Alternatively, the nozzle device 100 may be connected to the hot water pipe 43. When the hot water valve 41 is opened, hot water may be supplied to the nozzle device 100 through the hot water pipe 43.

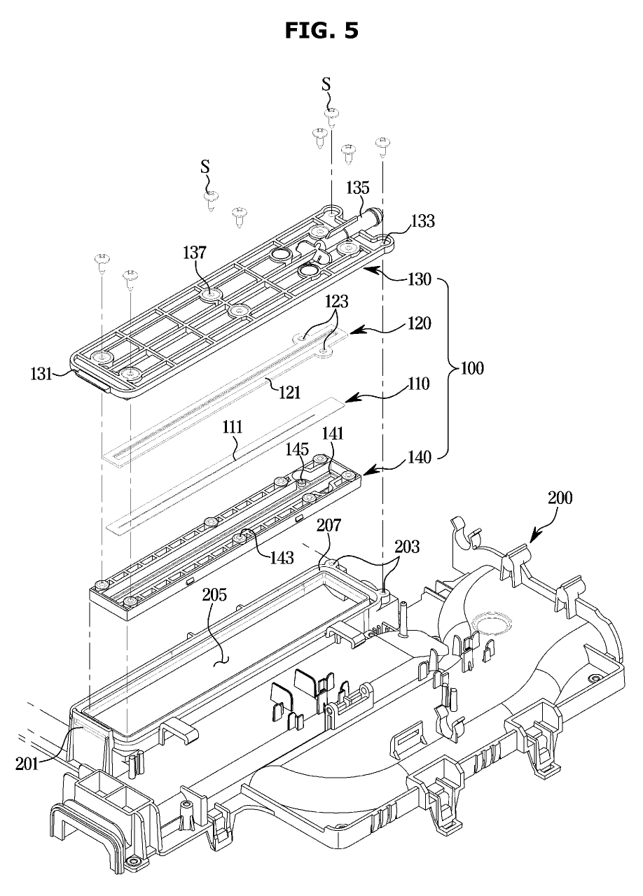

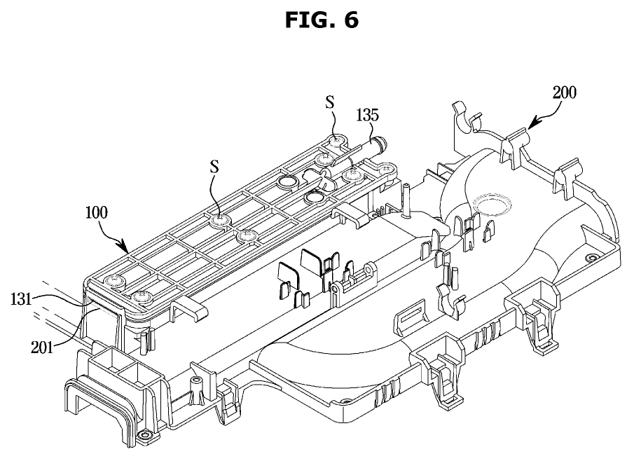

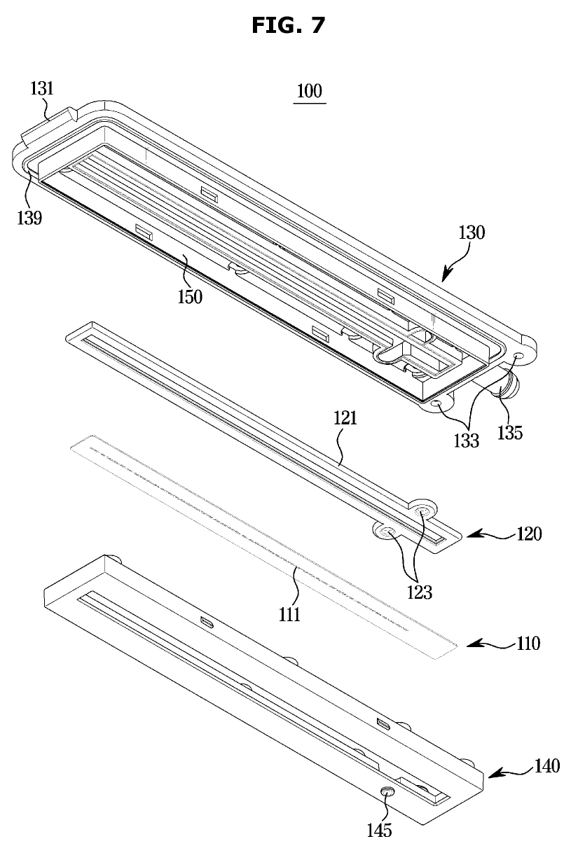

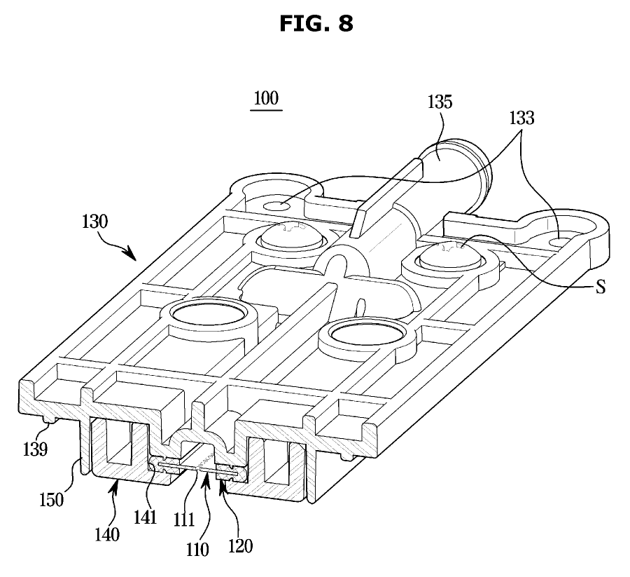

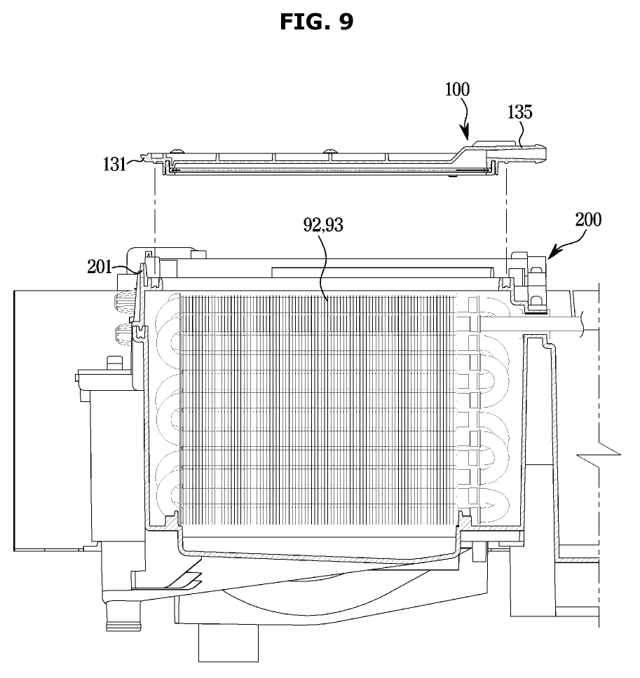

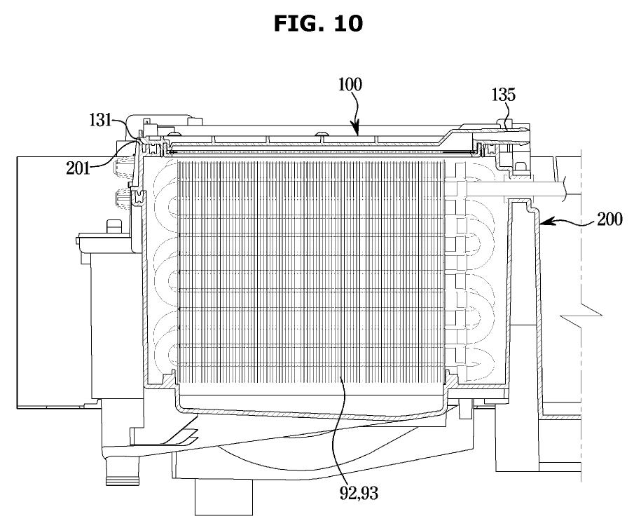

FIG. 5 is an exploded perspective view of a nozzle device fastened to a drying cover according to various embodiments. FIG. 6 is a perspective view of the nozzle device fastened to the drying cover according to various embodiments. FIG. 7 is an exploded perspective view of the nozzle device according to various embodiments. FIG. 8 is a perspective cross-sectional view of the nozzle device according to various embodiments. FIG. 9 is a cross-sectional view of the nozzle device being fastened to the drying cover according to various embodiments. FIG. 10 is a cross-sectional view of the nozzle device fastened to the drying cover, according to various embodiments.

As shown in FIGS. 5 to 10, the nozzle device 100 may be fastened to the drying cover 200. The nozzle device 100 may be fastened to the drying cover 200 in the vertical direction. The nozzle device 100 may be fastened to the drying cover 200 from an upper side of the drying cover 200. Since the nozzle device 100 is fastened to the drying cover 200 from the upper side of the drying cover 200, a gap between the nozzle device 100 and the heat exchangers 92 and 93 may be minimized/reduced when the nozzle device 100 is fastened to the drying cover 200.

When the nozzle device 100 is slidably fastened to the drying cover 200 in a horizontal direction, the nozzle device 100 may tilt and come into contact with the heat exchangers 92 and 93 positioned below the drying cover 200 during the process of fastening the nozzle device 100. Once the nozzle device 100 comes into contact with the heat exchangers 92 and 93, the heat exchangers 92 and 93 may be damaged. Therefore, when the nozzle device 100 is fastened to the drying cover 200 in the vertical direction, damage to the heat exchangers 92 and 93 may be prevented/reduced while minimizing/reducing the gap between the nozzle device 100 and the heat exchangers 92 and 93.

Since the gap between the nozzle device 100 and the heat exchangers 92 and 93 may be minimized/reduced by fastening the nozzle device 100 to the drying cover 200 in the vertical direction, even when the water pressure of the washing water supplied to the nozzle device 100 is high and the sprayed washing water is sprayed in an oblique direction, an area of the heat exchangers 92 and 93 that is not washed may be minimized/reduced. Since the gap between the nozzle device 100 and the heat exchangers 92 and 93 may be minimized/reduced by fastening the nozzle device 100 to the drying cover 200 in the vertical direction, even when the water pressure of the washing water supplied to the nozzle device 100 is low and the washing water clumps, an area of the heat exchangers 92 and 93 that is not washed may be minimized/reduced.

The drying cover 200 may cover an upper portion of the heat exchangers 92 and 93. The nozzle device 100 fastened to the drying cover 200 may spray washing water onto the heat exchangers 92 and 93. The heat exchangers 92 and 93 may be washed by the washing water sprayed from the nozzle device 100.

The nozzle device 100 may include a nozzle 110. The nozzle 110 may be seated in a lower nozzle case 140. The nozzle 110 may include a plurality of nozzle holes 111. Washing water supplied to the nozzle device 100 may be supplied to the nozzle 110. The washing water supplied to the nozzle 110 may be sprayed onto the heat exchangers 92 and 93 through the plurality of nozzle holes 111. The heat exchangers 92 and 93 may be washed by the washing water sprayed from the plurality of nozzle holes 111.

The nozzle device 100 may include a sealing member (e.g., including a seal) 120. The sealing member 120 may be configured to surround an edge of the nozzle 110. The sealing member 120 may be assembled to the edge of the nozzle 110. The sealing member 120 may be assembled to the edge of the nozzle 110 to surround the edge of the nozzle 110. The sealing member 120 surrounding the edge of the nozzle 110 may prevent/reduce leakage of the washing water supplied to the nozzle 110.

The sealing member 120 may be assembled to the edge of the nozzle 110 to surround only the nozzle 110, so that the sealing member 120 may be easily assembled. In addition, the sealing member 120 may be assembled to the edge of the nozzle 110 in order to surround the nozzle 110 and then the nozzle 110 may seated in the lower nozzle case 140 in the vertical direction, so that the sealing member 120 assembled to the nozzle 110 may be easily seated in the lower nozzle case 140.

The sealing member 120 may include a sealing portion 121 configured to surround the edge of the nozzle 110. When the sealing member 120 is assembled to the edge of the nozzle 110, the sealing portion 121 may surround the edge of the nozzle 110. The sealing portion 121 surrounding the edge of the nozzle 110 may prevent/reduce leakage of the washing water supplied to the plurality of nozzle holes 111.

The sealing member 120 may include a first discharge hole 123 formed in the sealing portion 121. At least one first discharge hole 123 may be formed in the sealing portion 121. Although a pair of first discharge holes 123 is illustrated in the drawings as being formed on both sides of the sealing portion 121, the present disclosure is not limited thereto. For example, the first discharge hole 123 may be formed only on one side of the sealing portion 121.

The first discharge hole 123 may cause, when the water pressure of the washing water supplied to the plurality of nozzle holes 111 is high, a portion of the washing water to be supplied directly discharged to the heat exchangers 92 and 93 without being supplied to the plurality of nozzle holes 111. When the water pressure of the washing water supplied to the plurality of nozzle holes 111 is high, the washing water sprayed from the plurality of nozzle holes 111 may fall in an oblique direction instead of falling vertically toward the heat exchangers 92 and 93. When the washing water sprayed from the plurality of nozzle holes 111 falls in an oblique direction, some parts of the heat exchangers 92 and 93 may not be washed because the washing water does not fall. When the water pressure of the washing water supplied to the plurality of nozzle holes 111 is high, and a portion of the washing water is discharged to the heat exchangers 92 and 93 through the first discharge holes 123, the water pressure of the washing water may decrease, and the washing water sprayed from the plurality of nozzle holes 111 may fall vertically toward the heat exchangers 92 and 93.

The nozzle device 100 may include an upper nozzle case 130. The upper nozzle case 130 may be fastened to the drying cover 200. By fastening the upper nozzle case 130 to the drying cover 200, the nozzle device 100 may be fastened to the drying cover 200.

The upper nozzle case 130 may include an assembly protrusion 131. The assembly protrusion 131 may be fitted and assembled into an assembly hole 201 formed in the drying cover 200. When fastening the nozzle device 100 to the drying cover 200, the nozzle device 100 may be fixed by fitting and assembling the assembly protrusion 131 of the upper nozzle case 130 into the assembly hole 201 of the drying cover 200.

The upper nozzle case 130 may include a second fastening hole 133. The nozzle device 100 may be fastened to the drying cover 200 through the second fastening hole 133. The second fastening hole 133 of the upper nozzle case 130 may be fastened to a first fastening hole 203 of the drying cover 200 by a fastening member S. The nozzle device 100 may be fastened to the drying cover 200 by fitting and assembling the assembly protrusion 131 of the upper nozzle case 130 into the assembly hole 201 of the drying cover 200, and then fastening the fastening member S to the second fastening hole 133 of the upper nozzle case 130 and the first fastening hole 203 of the drying cover 200.

The upper nozzle case 130 may include a connection portion 135. The connection portion 135 may be connected to the water supply pipes 43 and 44 that supply washing water to the nozzle device 100. The washing water supplied to the connection portion 135 through the water supply pipes 43 and 44 may be supplied to the plurality of nozzle holes 111 formed in the nozzle 110. The washing water supplied to the plurality of nozzle holes 111 may be sprayed onto the heat exchangers 92 and 93 through the plurality of nozzle holes 111 to clean the heat exchangers 92 and 93.

The upper nozzle case 130 may include a first case assembly hole 137. The lower nozzle case 140 may be assembled to the first case assembly hole 137 of the upper nozzle case 130. The lower nozzle case 140 may be assembled to the upper nozzle case 130 by an assembly member S assembled to a second case assembly hole 143 formed in the lower nozzle case 140 and the first case assembly hole 137 formed in the upper nozzle case 130. The assembly member S may be the same as the fastening member S.

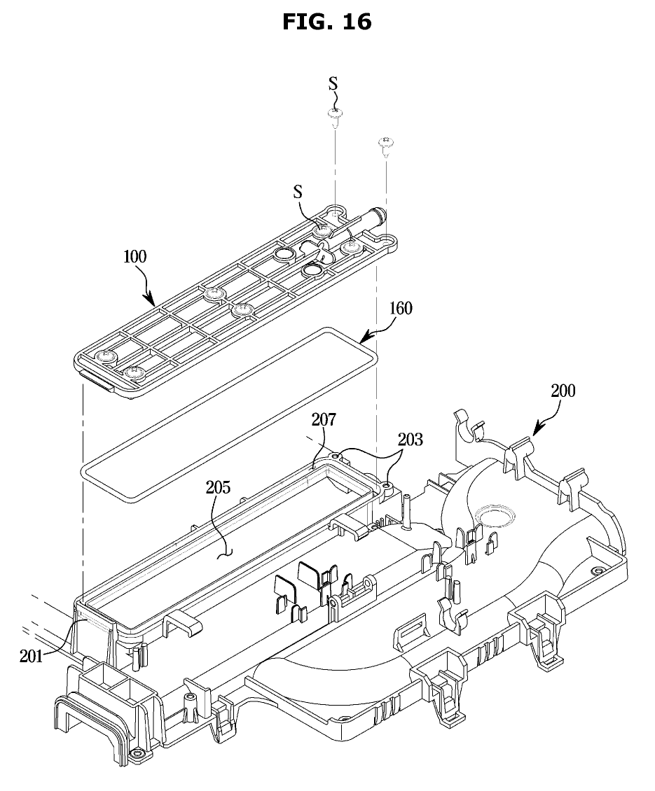

The upper nozzle case 130 may include a second pressing rib 139. The second pressing rib 139 may press an anti-leakage sealing member 160 (see, e.g., FIG. 16), which will be described in greater detail below. The second pressing rib 139 may press the anti-leakage sealing member 160 seated in a sealing member seating groove 207 formed in the drying cover 200. By the anti-leakage sealing member 160 pressing the second pressing rib 139, the anti-leakage sealing member 160 disposed between the nozzle device 100 and the drying cover 200 may effectively prevent/block the washing water supplied to the nozzle device 100 from leaking out of the drying cover 200.

The nozzle device 100 may include the lower nozzle case 140. The lower nozzle case 140 may be assembled to a lower portion of the upper nozzle case 130. The nozzle 110 may be seated in the lower nozzle case 140. When the nozzle device 100 is fastened to the drying cover 200, the lower nozzle case 140 may be received inside a receiving hole 205 of the drying cover 200.

The lower nozzle case 140 may include a seating portion 141. The nozzle 110 may be seated in the seating portion 141. The nozzle 110 with the sealing member 120 assembled to its edge may be seated in the seating portion 141. The seating portion 141 may be configured to be open at an upper portion and a lower portion. In other words, the seating portion 141 may be configured such that the edge of the nozzle 110 is seated. The nozzle 110 seated in the seating portion 141 may spray washing water onto the heat exchangers 92 and 93 through an open lower portion of the seating portion 141.

The lower nozzle case 140 may include the second case assembly hole 143. The second case assembly hole 143 may be formed at a position corresponding to the first case assembly hole 137 formed in the upper nozzle case 130. The upper nozzle case 130 may be assembled to the second case assembly hole 143 of the lower nozzle case 140. The lower nozzle case 140 may be assembled to the upper nozzle case 130 by the assembly member S assembled to the second case assembly hole 143 formed in the lower nozzle case 140 and the first case assembly hole 137 formed in the upper nozzle case 130.

The lower nozzle case 140 may include a second discharge hole 145. The second discharge hole 145 may be formed at a position corresponding to the first discharge hole 123 formed in the sealing member 120. At least one second discharge hole 145 may be formed in the lower nozzle case 140. Although only one second discharge hole 145 is illustrated in the drawings as being formed in the lower nozzle case 140, the present disclosure is not limited thereto.

The second discharge hole 145 may be formed at a position corresponding to one of the pair of first discharge holes 123 formed in the sealing member 120. When the water pressure of the washing water supplied to the plurality of nozzle holes 111 is high, a portion of the supplied washing water may not be supplied to the plurality of nozzle holes 111 but may be discharged to the heat exchangers 92 and 93 through the first discharge holes 123 of the sealing member 120 and the second discharge hole 145 of the lower nozzle case 140. In other words, the washing water discharged through the first discharge holes 123 of the sealing member 120 may be discharged to the heat exchangers 92 and 93 through the second discharge hole 145 of the lower nozzle case 140.

When the water pressure of the washing water supplied to the plurality of nozzle holes 111 is high, the washing water sprayed from the plurality of nozzle holes 111 may fall in an oblique direction instead of falling vertically toward the heat exchangers 92 and 93. When the washing water sprayed from the plurality of nozzle holes 111 falls in an oblique direction, some parts of the heat exchangers 92 and 93 are not cleaned because the washing water does not fall. When the water pressure of the washing water supplied to the plurality of nozzle holes 111 is high, and a portion of the washing water is discharged to the heat exchangers 92 and 93 through the first discharge holes 123 and the second discharge hole 145, the water pressure may be decrease, and the washing water sprayed from the plurality of nozzle holes 111 may fall vertically toward the heat exchangers 92 and 93.

The nozzle device 100 may include a leakage-proof rib 150. The leakage-proof rib 150 may be configured to extend downwardly from an upper wall of the upper nozzle case 130. The leakage-proof rib 150 may be formed in a rectangular shape. The lower nozzle case 140 may be received inside the leakage-proof rib 150 having a rectangular shape. In other words, when the lower nozzle case 140 is assembled to the upper nozzle case 130, the lower nozzle case 140 may be received in the inside of the leakage-proof rib 150.

Because the lower nozzle case 140 is received inside the leakage-proof rib 150, the washing water that is supplied to the nozzle 110 seated in the lower nozzle case 140 and sprayed through the plurality of nozzle holes 111 may be prevented/blocked from leaking out of the upper nozzle case 130 by the leakage-proof rib 150. The washing water that is supplied to the nozzle 110 seated in the lower nozzle case 140 and sprayed through the plurality of nozzle holes 111 may be prevented/blocked by the sealing member 120, but even if the sealing member 120 is broken, the washing water may be dually prevented/reduced from leaking by the leakage-proof rib 150. For example, the washing water that is supplied to the nozzle device 100 and sprayed through the plurality of nozzle holes 111 may be primarily prevented/blocked from leaking out of the nozzle device 100 by the sealing member 120, and may be secondarily prevented/blocked from leaking out of the nozzle device 100 by the leakage-proof rib 150.

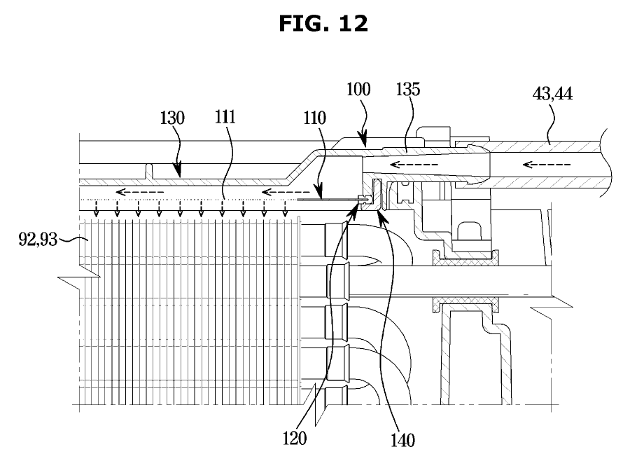

The lower nozzle case 140 may be received inside the leakage-proof rib 150, so the leakage-proof rib 150 may be positioned between the receiving hole 205 of the drying cover 200 and the lower nozzle case 140. The leakage-proof rib 150 may be configured to extend to a position corresponding to a lower end of the lower nozzle case 140 received inside the leakage-proof rib 150 (see, e.g., FIG. 12).

The nozzle device 100 may be fastened to the drying cover 200 that covers the upper portion of the heat exchangers 92 and 93. The drying cover 200 may include the assembly hole 201. The assembly hole 201 may be formed adjacent to an edge of the receiving hole 205. One end of the upper nozzle case 130 may be fitted and assembled into the assembly hole 201. The assembly protrusion 131 formed at one end of the upper nozzle case 130 may be fitted and assembled into the assembly hole 201. When fastening the nozzle device 100 to the drying cover 200, the nozzle device 100 may be fixed by fitting and assembling the assembly protrusion 131 of the upper nozzle case 130 into the assembly hole 201 of the drying cover 200.

The drying cover 200 may include the first fastening hole 203. The first fastening hole 203 may be formed on an opposite side of the assembly hole 201 among the edges of the receiving hole 205. The other end of the upper nozzle case 130 may be fastened to the first fastening hole 203. The second fastening hole 133 formed at the other end of the upper nozzle case 130 may be fastened to the first fastening hole 203 by the fastening member S. The nozzle device 100 may be fastened to the drying cover 200 by fitting and assembling the assembly protrusion 131 of the upper nozzle case 130 into the assembly hole 201 of the drying cover 200, and then fastening the fastening member S to the second fastening hole 133 of the upper nozzle case 130 and the first fastening hole 203 of the drying cover 200.

The drying cover 200 may include the receiving hole 205. When the nozzle device 100 is fastened to the drying cover 200, a portion of the nozzle device 100 may be received in the receiving hole 205. When the nozzle device 100 is fastened to the drying cover 200, the lower nozzle case 140 may be received inside the receiving hole 205. A lower end of the receiving hole 205 and a lower end of the lower nozzle case 140 received inside the receiving hole 205 may be configured to have corresponding heights. The nozzle device 100 fastened to the drying cover 200 may spray the washing water supplied to the nozzle device 200 onto the heat exchangers 92 and 93 through the receiving hole 205.

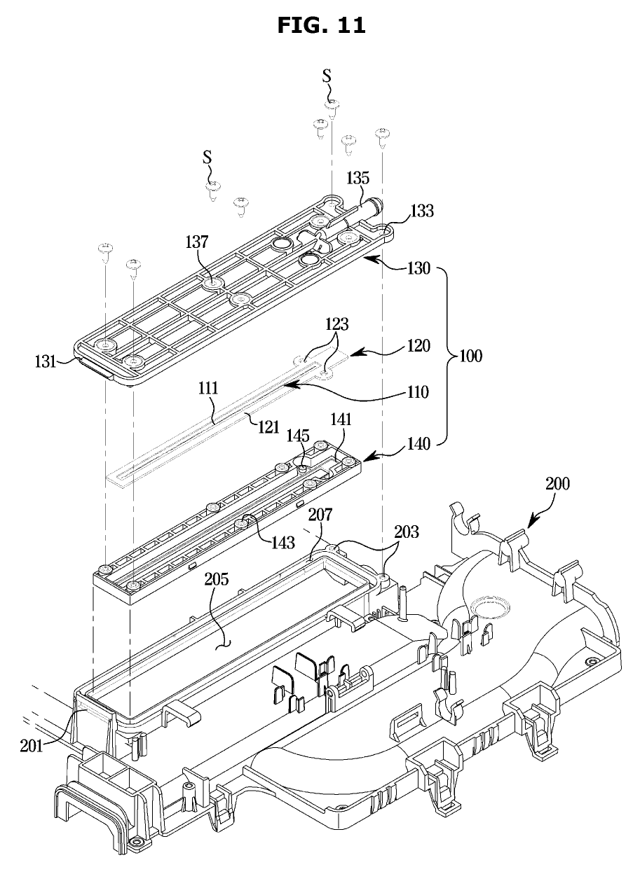

FIG. 11 is an exploded perspective view of a state in which a nozzle and a sealing member are integrally provided in FIG. 5 according to various embodiments.

As shown in FIG. 11, the nozzle 110 of the nozzle device 100 and the sealing member 120 configured to surround the edge of the nozzle 110 may be integrally provided. The remaining configuration of the nozzle device 100, except for the configuration in which the nozzle 110 and the sealing member 120 are integrally provided, may be the same as the configuration of the nozzle device 100 shown in FIGS. 5 to 10.

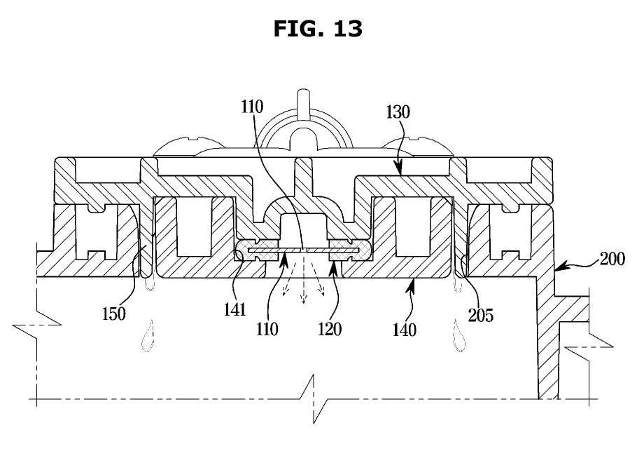

FIG. 12 is a cross-sectional view of a state in which washing water is supplied to the nozzle device through a water supply pipe and the washing water supplied to the nozzle device is sprayed onto a heat exchanger through a plurality of nozzle holes, according to various embodiments. FIG. 13 is a cross-sectional view of a state in which the washing water supplied to the nozzle device to be sprayed through a plurality of nozzle holes is prevented/blocked from leaking out of an upper nozzle case by a leakage-proof rib, according to various embodiments.

As shown in FIG. 12, the connection portion 135 formed on the upper nozzle case 130 of the nozzle device 100 may be connected to the water supply pipes 43 and 44. The washing water supplied through the water supply pipes 43 and 44 may be supplied into the nozzle device 100 through the connection portion 135. The washing water supplied into the nozzle device 100 through the connection portion 135 may be supplied to flow along the nozzle 110. The washing water flowing along the nozzle 110 may be sprayed onto the heat exchangers 92 and 93 through the plurality of nozzle holes 111.

As shown in FIG. 13, the washing water supplied to the nozzle device 100 to be sprayed through the plurality of nozzle holes 111 may be prevented/blocked/suppressed from leaking out of the upper nozzle case 130 by the leakage-proof rib 150. For example, the leakage-proof rib 150 may prevent/block the washing water supplied to the nozzle device 100 from leaking out of the drying cover 200. The leakage-proof rib 150 may be positioned between the receiving hole 205 and the lower nozzle case 140. The leakage-proof rib 150 may be configured to extend to a position corresponding to the lower end of the lower nozzle case 140. Due to the leakage-proof rib 150 positioned between the receiving hole 205 and the lower nozzle case 140, the washing water supplied to the nozzle 110 seated in the lower nozzle case 140 may fall into the drying cover 200 without leaking out of the drying cover 200.

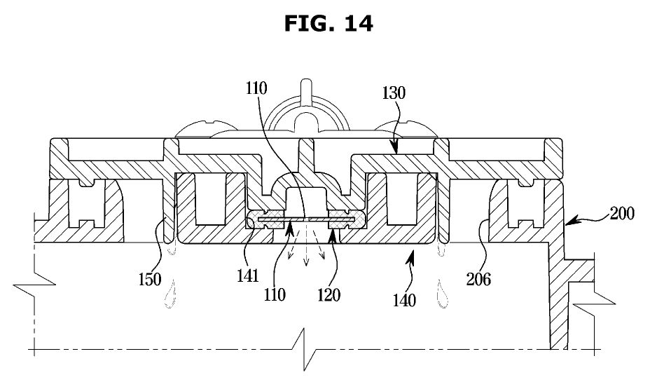

FIG. 14 is a cross-sectional view of a gap between a leakage-proof rib and a receiving hole formed wider than a gap between the leakage-proof rib and a lower nozzle case in FIG. 13 according to various embodiments.

As shown in FIG. 14, the washing water supplied to the nozzle device 100 to be sprayed through the plurality of nozzle holes 111 may be prevented/blocked from leaking out of the drying cover 200 by the leakage-proof rib 150. The leakage-proof rib 150 may be positioned between a receiving hole 206 and the lower nozzle case 140. The receiving hole 206 may be formed such that a gap between the leakage-proof rib 150 and the receiving hole 206 is wider than a gap between the leakage-proof rib 150 and the lower nozzle case 140. In other words, the receiving hole 206 may be formed wider than the receiving hole 205 shown in FIG. 13.

In case the gap between the leakage-proof rib 150 and the receiving hole 206 is narrow, the washing water may leak out of the drying cover 200 through the gap between the leakage-proof rib 150 and the receiving hole 206 by capillary action. Therefore, by widening the gap between the leakage-proof rib 150 and the receiving hole 206, the washing water may fall into the drying cover 200 instead of leaking out of the drying cover 200 through the gap between the leakage-proof rib 150 and the receiving hole 206 due to capillary action.

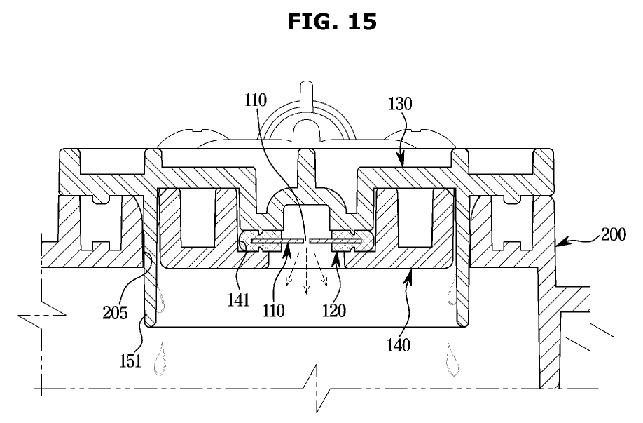

FIG. 15 is a cross-sectional view of the leakage-proof rib extending further downward than a lower end of a lower nozzle case in FIG. 13 according to various embodiments.

As shown in FIG. 15, the washing water supplied to the nozzle device 100 to be sprayed through the plurality of nozzle holes 111 may be prevented/blocked from leaking out of the drying cover 200 by a leakage-proof rib 151. The leakage-proof rib 151 may be positioned between the receiving hole 205 and the lower nozzle case 140. The leakage-proof rib 151 may extend further downward than the lower end of the lower nozzle case 140. When the leakage-proof rib 151 is arranged to extend further downward than the lower end of the lower nozzle case 140, the washing water supplied to the nozzle 110 seated in the lower nozzle case 140 may more effectively fall into the drying cover 200, rather than leaking out of the drying cover 200 due to the leakage-proof rib 151 positioned between the receiving hole 205 and the lower nozzle case 140.

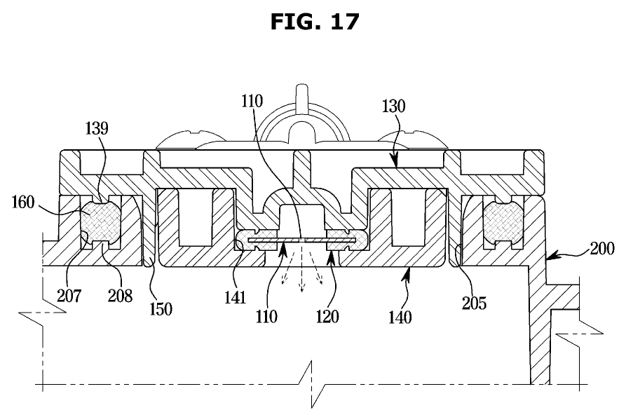

FIG. 16 is an exploded perspective view of an anti-leakage sealing member disposed between a drying cover and a nozzle device fastened to the drying cover, according to various embodiments. FIG. 17 is a cross-sectional view of the anti-leakage sealing member disposed between the drying cover and the nozzle device fastened to the drying cover, according to various embodiments.

As shown in FIGS. 16 to 17, the anti-leakage sealing member 160 may be provided between the drying cover 200 and the nozzle device 100 fastened to the drying cover 200. The anti-leakage sealing member 160 may be seated in the sealing member seating groove 207 of the drying cover 200 in order to be positioned between the nozzle device 100 and the drying cover 200. The sealing member seating groove 207 may be formed along the rim of the receiving hole 205. The anti-leakage sealing member 160 seated in the sealing member seating groove 207 may prevent/block the washing water supplied to the nozzle device 100 from leaking out of the drying cover 200.

The sealing member seating groove 207 may include a first pressing rib 208 that presses the anti-leakage sealing member 160 seated in the sealing member seating groove 207. The first pressing rib 208 may press the anti-leakage sealing member 160 from a lower side of the anti-leakage sealing member 160. By the first pressing rib 208 pressing the anti-leakage sealing member 160, the anti-leakage sealing member 160 disposed between the nozzle device 100 and the drying cover 200 may effectively prevent/block the washing water supplied to the nozzle device 100 from leaking out of the drying cover 200.

The upper nozzle case 130 positioned above the anti-leakage sealing member 160 may include the second pressing rib 139 that presses the anti-leakage sealing member 160. The second pressing rib 139 may press the anti-leakage sealing member 160 from an upper side of the anti-leakage sealing member 160. By the first pressing rib 208 and the second pressing rib 139 pressing the anti-leakage sealing member 160 from the lower and upper sides of the anti-leakage sealing member 160, respectively, the anti-leakage sealing member 160 disposed between the nozzle device 100 and the drying cover 200 may effectively prevent/block the washing water supplied to the nozzle device 100 from leaking out of the drying cover 200.

A clothes treating apparatus according to an example embodiment of the present disclosure may include the tub 20, the heat exchanger 92 or 93 disposed above the tub, the drying cover 200 configured to cover an upper portion of the heat exchanger, and the nozzle device 100 fastened to the drying cover in a vertical direction and configured to spray washing water onto the heat exchanger. The nozzle device may include the nozzle 110 including the plurality of nozzle holes 111 for spraying the washing water onto the heat exchanger, the sealing member 120 configured to surround an edge of the nozzle, the upper nozzle case 130 fastened to the drying cover, the lower nozzle case 140 assembled to a lower portion of the upper nozzle case and configured to seat the nozzle therein, and the leakage-proof rib 150 configured to extend downwardly from an upper wall of the upper nozzle case and configured to receive the lower nozzle case.

The drying cover may include the receiving hole 205 in which a portion of the nozzle device is received when the nozzle device is fastened to the drying cover, and when the nozzle device is fastened to the drying cover, the lower nozzle case may be received inside the receiving hole.

The leakage-proof rib may be positioned between the receiving hole and the lower nozzle case.

A lower end of the lower nozzle case may be configured to have a height corresponding to a lower end of the receiving hole.

The leakage-proof rib may be configured to extend to a position corresponding to the lower end of the lower nozzle case.

The leakage-proof rib 151 may be configured to extend further downward than the lower end of the lower nozzle case.

The leakage-proof rib may be positioned between the receiving hole and the lower nozzle case, and the receiving hole 206 may be formed such that a gap between the leakage-proof rib and the receiving hole is wider than a gap between the leakage-proof rib and the lower nozzle case.

The sealing member may include the first discharge hole 123 configured to discharge a portion of the washing water supplied to the heat exchanger when a water pressure of the washing water supplied to the nozzle is high.

The lower nozzle case may include the second discharge hole 145 formed to correspond to the first discharge hole and configured to discharge the washing water discharged through the first discharge hole to the heat exchanger.

The nozzle may be seated in the lower nozzle case after the sealing member is assembled.

The nozzle may be integrally provided with the sealing member and seated in the lower nozzle case.

The anti-leakage sealing member 160 may be provided between the nozzle device and the drying cover to prevent/block the washing water from leaking out of the drying cover.

The drying cover may include the sealing member seating groove 207 formed along an edge of the receiving hole and in which the anti-leakage sealing member is seated.

The sealing member seating groove may include the first pressing rib 208 configured to press the anti-leakage sealing member seated in the sealing member seating groove.

The upper nozzle case may include the second pressing rib 139 configured to press the anti-leakage sealing member seated in the sealing member seating groove.

A clothes treating apparatus according to an example embodiment of the present disclosure includes the tub 20, the heat exchangers 92 and 93 disposed above the tub, the drying cover 200 configured to cover an upper portion of the heat exchanger and including the receiving hole 205, and the nozzle device 100 fastened to the drying cover in a vertical direction such that a portion thereof is received in the receiving hole, and configured to spray washing water onto the heat exchanger. The nozzle device may include the nozzle 110 including the plurality of nozzle holes 111 for spraying the washing water onto the heat exchanger, the sealing member 120 assembled to the nozzle to surround an edge of the nozzle, the upper nozzle case 130 fastened to the drying cover, the lower nozzle case 140 assembled to a lower portion of the upper nozzle case to be received in the receiving hole and configured to seat the nozzle therein, and the leakage-proof rib 150 configured to extend downwardly from an upper wall of the upper nozzle case in order to be positioned between the receiving hole and the lower nozzle case.

The sealing member may include the sealing portion 121 configured to surround the edge of the nozzle to prevent/block/reduce leakage of washing water supplied to the plurality of nozzle holes, and the first discharge hole 123 formed in the sealing portion and configured to discharge a portion of the washing water supplied to the heat exchanger when a water pressure of the washing water supplied to the plurality of nozzle holes is high.

The drying cover may include the assembly hole 201 formed adjacent to an edge of the receiving hole and into which one end of the upper nozzle case is fitted and assembled, and the first fastening hole 203 formed on an opposite side of the assembly hole among the edges of the receiving hole and to which the other end of the upper nozzle case is fastened.

The upper nozzle case may include the assembly protrusion 131 fitted and assembled into the assembly hole, the second fastening hole 133 fastened to the first fastening hole by a fastening member, the connection portion 135 to which a water supply pipe for supplying washing water to the plurality of nozzle holes is connected, and the first case assembly hole 137 to which the lower nozzle case is assembled.

The lower nozzle case may include the seating portion 141 in which the nozzle is seated, the second case assembly hole 143 formed at a position corresponding to the first case assembly hole and assembled to the upper nozzle case, and the second discharge hole 145 formed at a position corresponding to the first discharge hole configured to discharge the washing water discharged through the first discharge hole to the heat exchanger.

According to the present disclosure, the assemblability of the nozzle device for washing the heat exchanger can be improved.

The shape of the sealing member can be simplified because the sealing member that seals the nozzle to prevent/reduce leakage of the washing water supplied to the nozzle device is formed to surround the edge of the nozzle.

By simplifying the shape of the sealing member, the nozzle assembled with the sealing member can be easily seated in the lower nozzle case.

The nozzle device can be easily fastened to the drying cover by fastening the nozzle device to the drying cover in the vertical direction.

The gap between the nozzle device and the heat exchanger can be minimized/reduced by fastening the nozzle device to the drying cover in the vertical direction.

The leakage of washing water can be dually prevented/reduced because the leakage-proof rib configured to prevent/block leakage of the washing water supplied to the nozzle device is formed on the upper nozzle case.

The effects that can be obtained from the present disclosure are not limited to the effects mentioned above, and other effects not mentioned will be clearly understood by one of ordinary skill in the art to which the disclosure pertains.

Although the clothes treating apparatus has been described with reference to the attached drawings, focusing on specific shapes and directions, various modifications and changes can be made by one of ordinary skill in the art, and such modifications and changes should be interpreted as being included within the scope of the present disclosure.

What is claimed is:

1. A clothes treating apparatus, comprising:
a tub;
a heat exchanger disposed above the tub;
a drying cover covering an upper portion of the heat exchanger; and
a nozzle device fastened to the drying cover in a vertical direction and configured to spray washing water onto the heat exchanger,
wherein the nozzle device comprises:
a nozzle comprising a plurality of nozzle holes configured to spray the washing water onto the heat exchanger;
a sealing member comprising a seal configured to surround an edge of the nozzle;
an upper nozzle case fastened to the drying cover;
a lower nozzle case assembled to a lower portion of the upper nozzle case and configured to seat the nozzle therein; and
a leakage-proof rib extending downwardly from an upper wall of the upper nozzle case and configured to receive the lower nozzle case.

2. The clothes treating apparatus of claim 1, wherein
the drying cover comprises a receiving hole in which a portion of the nozzle device is received based on the nozzle device being fastened to the drying cover, and
based on the nozzle device being fastened to the drying cover, the lower nozzle case is received inside the receiving hole.

3. The clothes treating apparatus of claim 2, wherein the leakage-proof rib is positioned between the receiving hole and the lower nozzle case.

4. The clothes treating apparatus of claim 2, wherein a lower end of the lower nozzle case has a height corresponding to a lower end of the receiving hole.

5. The clothes treating apparatus of claim 4, wherein the leakage-proof rib extends to a position corresponding to the lower end of the lower nozzle case.

6. The clothes treating apparatus of claim 4, wherein the leakage-proof rib extends further downward than the lower end of the lower nozzle case.

7. The clothes treating apparatus of claim 2, wherein
the leakage-proof rib is positioned between the receiving hole and the lower nozzle case, and
the receiving hole having a gap between the leakage-proof rib and the receiving hole wider than a gap between the leakage-proof rib and the lower nozzle case.

8. The clothes treating apparatus of claim 1, wherein the sealing member comprises a first discharge hole configured to discharge a portion of the washing water supplied to the nozzle to the heat exchanger based on a water pressure of the washing water being greater than a specified pressure.

9. The clothes treating apparatus of claim 8, wherein the lower nozzle case comprises a second discharge hole corresponding to the first discharge hole and configured to discharge the washing water discharged through the first discharge hole to the heat exchanger.

10. The clothes treating apparatus of claim 1, wherein the nozzle is seated in the lower nozzle case after the sealing member is assembled.

11. The clothes treating apparatus of claim 1, wherein the nozzle is integrally provided with the sealing member and is seated in the lower nozzle case.

12. The clothes treating apparatus of claim 2, wherein an anti-leakage sealing member is provided between the nozzle device and the drying cover and configured to block to the washing water from leaking out of the drying cover.

13. The clothes treating apparatus of claim 12, wherein the drying cover comprises a sealing member seating groove formed along an edge of the receiving hole and in which the anti-leakage sealing member is seated.

14. The clothes treating apparatus of claim 13, wherein the sealing member seating groove comprises a first pressing rib configured to press the anti-leakage sealing member seated in the sealing member seating groove.

15. The clothes treating apparatus of claim 14, wherein the upper nozzle case comprises a second pressing rib configured to press the anti-leakage sealing member seated in the sealing member seating groove.
